(19) United States
(12) Patent Application Publication
(10) Pub. No.: US 2006/0117198 A1
(43) Pub. Date: Jun. 1, 2006

(54) Electronic apparatus and power control method

(75) Inventor: Nobuaki Takasu, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/247,190

(22) Filed: Oct. 12, 2005

(30) Foreign Application Priority Data
Nov. 30, 2004 (JP) 2004-347158

(51) Int. Cl. G06F 1/30

(52) U.S. Cl. 713/323

(57) ABSTRACT

An electronic apparatus comprises a connector which is connected with an external apparatus, a communication control unit which performs communication with the external apparatus via the connector, a first power supply circuit which supplies an electric power obtained from an external power supply to the communication control unit, a second power supply circuit which supplies an electric power obtained from the external apparatus via the connector to the communication control unit, and a control unit which supplies an electric power obtained from the first power supply circuit to the communication control unit when the first power supply circuit obtains an electric power from the external power supply, and which supplies an electric power obtained from the second power supply circuit to the communication control unit when the first power supply circuit does not obtain an electric power from the external power supply.

### CROSS-REFERENCE TO RELATED APPLICATIONS

This application is based upon and claims the benefit of priority from prior Japanese Patent Application No. 2004-347158, filed Nov. 30, 2004, the entire contents of which are incorporated herein by reference.

### BACKGROUND

1. Field

The present invention relates to an electronic apparatus powered by battery, such as a notebook (laptop) personal computer, and to a power control method.

2. Description of the Related Art

An electronic apparatus powered by battery, for example, a notebook personal computer (notebook PC) consumes much energy. When the notebook PC is powered by battery the operable time is insufficient. In particular, when the foregoing electronic apparatus communicates with an external apparatus, continuous operation of an internal communication control circuit of the apparatus is required. In this case, the energy consumption of the electronic apparatus increases greatly.

There has been known a technique such that the electronic apparatus is capable of obtaining energy from other sources excluding a battery power supply and external power supply. According to the technique, the electronic apparatus obtains the energy from an external apparatus capable of supplying power via a communication cable. The foregoing technique is disclosed in JPN. PAT. APPLN. KOKAI Publication No. 2004-133737, for example.

According to the technique, the electronic apparatus obtains power from the external apparatus via a communication cable. However, this is a technique of obtaining power for the purpose of protecting the operation of the apparatus if a failure occurs in a normal power supply to the electronic apparatus. Therefore, the foregoing technique does not serve to extend the operable time when the electronic apparatus is powered by battery.

### BRIEF DESCRIPTION OF THE SEVERAL VIEWS OF THE DRAWING

The accompanying drawings, which are incorporated in and constitute a part of the specification, illustrate embodiments of the invention, and together with the detailed description of the embodiments given below, serve to explain the principles of the invention.

FIG. 1 is a view showing the appearance of a notebook PC according to a first embodiment of the present invention;

FIG. 2 is a block diagram showing the configuration of an internal circuit of the notebook PC according to the first embodiment of the present invention;

FIG. 3 is a flowchart to explain the power control procedure executed by the notebook PC according to the first embodiment of the present invention;

FIG. 4 is a table to explain connection and power supply when the notebook PC according to the first embodiment of the present invention executes the power control procedure;

FIG. 5 is a view showing a setting screen when the notebook PC according to the first embodiment of the present invention executes the power control procedure;

FIG. 6 is a flowchart to explain the reset procedure executed by the notebook PC according to the first embodiment of the present invention;

FIG. 7 is a view showing a setting screen when the notebook PC according to the second embodiment of the present invention executes the power control procedure;

FIG. 8 is a view showing a setting screen of the “Wake on LAN” function of the notebook PC according to the third embodiment of the present invention;

FIG. 9 is a block diagram showing the internal circuit configuration of the notebook PC according to the third embodiment; and

FIG. 10 is a flowchart to explain the power control procedure executed by the notebook PC according to the third embodiment of the present invention.

### DETAILED DESCRIPTION

Embodiments in which the present invention is applied to a notebook personal computer (hereinafter, referred to as notebook PC) will be described below with reference to the accompanying drawings.

The first embodiment of the present invention will be explained below.

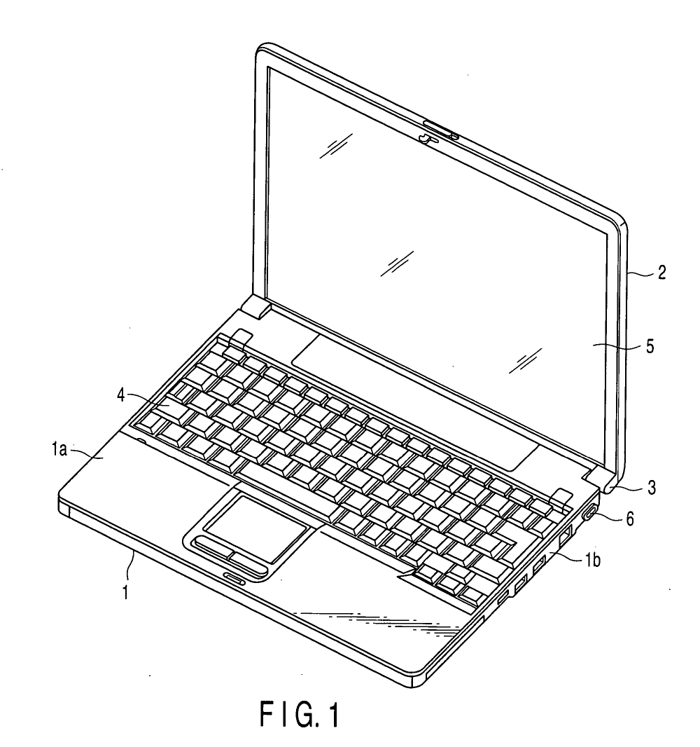

FIG. 1 is a view showing the appearance of a notebook PC according to a first embodiment of the present invention.

As shown in FIG. 1, the notebook PC according to the first embodiment of the present invention has a main case 1, a display case 2 and a hinge 3. An upper surface 1a of the main case 1 is provided with a keyboard 4 for input operation by user.

The display case 2 supports the peripheral portion of a display device, that is, a liquid crystal display (LCD) 5 from inside so that the user can see it. By doing so, the display plane of the LCD 5 is attached so that the user can see it.

The hinge 3 connects the main case 1 and the display case 2. The hinge 3 rotatably supports the display case 2 around a rotatable shaft (not shown) between open and closed states. The closed state is a sate that the display case 2 covers the keyboard 4. The open state is a state that the keyboard 4 is exposed so that the user can see it.

A side 1b of the main case 1 is provided with a power switch 6. The power switch 6 is a device for switching a system state (operating state) of the notebook PC, that is, making a switchover between the following states. One is a state that the operating system (OS) is booting (hereinafter, referred to as boot state). Another is a state that the OS ends (hereinafter, referred to as shutdown state).

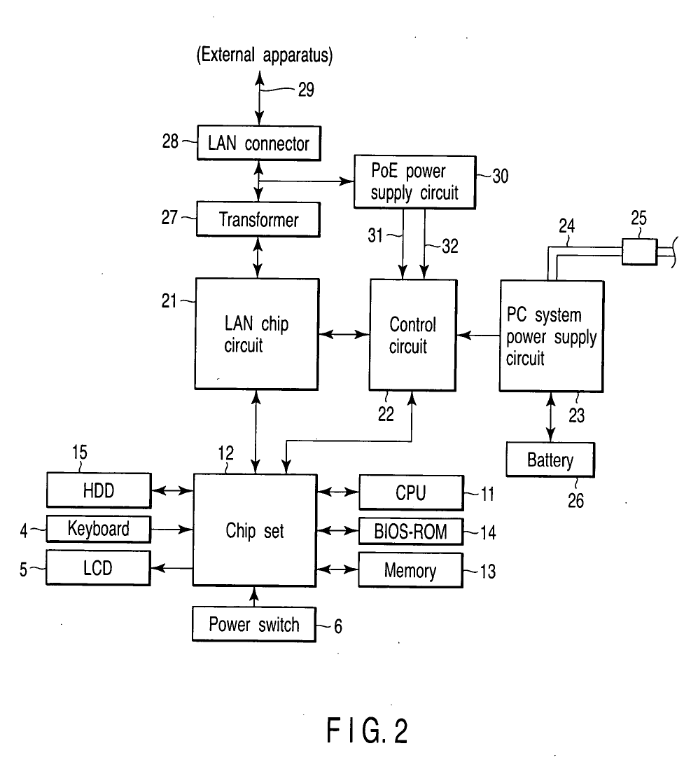

FIG. 2 is a block diagram showing the configuration of an internal circuit of the notebook PC according to the first embodiment of the present invention.

In FIG. 2, there are shown only configuration of internal circuits of the notebook PC relevant to the present invention. The notebook PC is provided with a CPU 11 for controlling the entirety of the notebook PC. The CPU 11 is connected with a chip set 12.

The chip set 12 has the following functions. One is a function of executing data and address conversion with the CPU 11. Another is a function of executing data input/output processing between devices. The chip set 12 is connected with a main memory 13, which is used as a work area when the CPU 11 is operating. In addition, the chip set 12 is connected with the LCD 5, the keyboard 4, the power switch 6, a BIOS-ROM 14 and a hard disk drive (HDD) 15.

The BIOS-ROM 14 is stored with a program for executing basic input/output control and power state management in of the notebook PC. Moreover, the BIOS-ROM 14 is stored with a control (procedure) program.

The control procedure program is a program for controlling the supply of power to various devices of the notebook PC (hereinafter, referred to as power control procedure) if the following condition is satisfied. The condition is that user presses the power switch 6, and in addition, a predetermined condition is satisfied. The foregoing various devices are, for example, the CPU 11, the LCD 5, the main memory 13, the HDD 15, etc.

The HDD 15 is a non-volatile storage medium, and therefore, a device capable of storing data even when the power of the notebook PC is not made. The HDD 15 is stored with OS and application programs. If the CPU 11 executes the foregoing programs, these programs are properly developed in the main memory 13.

The chip set 12 detects press (depression) of the power switch 6 by user. On detecting the press of the power switch 6 by user, the chip set 12 determines the current system state of the notebook PC. The chip set 12 transfers the system state between the boot state and the shutdown state.

For example, when the system state is in a shutdown state when the press of the power switch 6 by user is detected, the chip set 12 transfers the system state of the notebook PC to the boot state. When the system state of the notebook PC transfers to the boot state, the CPU 11 controls the supply of power to various devices of the notebook PC.

Moreover, the chip set 12 is connected with a local area network (LAN) chip circuit 21 and a control circuit 22. A PC system power supply circuit 23 is connected with a power supply plug 25 via a power cord 24.

The PC system power supply circuit 23 supplies power required for various devices such as the CPU 11 and the LAN chip circuit 21 via voltage conversion when power is obtained from an external power supply (AC power supply) via the foregoing plug 25 and cord 24.

The PC system power supply circuit 23 is connected with a battery 26. The PC system power supply circuit 23 obtains power from the battery 26 when power is not obtained from the external power supply (AC power supply). By doing so, the PC system power supply circuit 23 supplies power required for various devices to the control circuit 22 via voltage conversion.

The LAN chip circuit 21 is connected with a LAN connector 28 via a transformer 27. The LAN connector 28 is a connector capable of connecting a LAN cable 29. In a state that the LAN connector 28 is connected with the LAN cable 29, the LAN chip circuit 21 makes a data exchange with external apparatus via transformer 27, LAN connector 28 and LAN cable 29.

The LAN connector 28 is connected with a power over ethernet (PoE) power supply circuit 30. The PoE power supply circuit 30 is connected with the control circuit 22 via a power line 31. Moreover, the PoE power supply circuit 30 is connected with the control circuit 22 via a control signal line 32. When the external apparatus connected with the LAN connector 28 via the LAN cable 29 is a PoE-enabled apparatus, power is supplied.

Specifically, power is supplied to the PoE power supply circuit 30 from the external apparatus via LAN cable 29 and LAN connector 28. The PoE-enabled apparatus implies an apparatus capable of supplying power to the notebook PC via the LAN cable 29.

If power is obtained from the foregoing external apparatus, the PoE power supply circuit 30 supplies power required for the LAN chip circuit 21 to the control circuit 22 via the power line 31 after voltage conversion.

The control circuit 22 has a function of switching a connection with the PoE power supply circuit 30 via the power line 31. Power is supplied in accordance with the following cases.

According to one case, the control circuit 22 makes no connection with the PoE power supply circuit 30 via the power line 31. In this case, the control circuit 22 supplies power supplied from the PC system power supply circuit 23 to various devices requiring the power. The foregoing various devices include the LAN chip circuit 21.

According to another case, the control circuit 22 makes a connection with the circuit 30 via the power line 31 so that the PoE power supply circuit 30 obtains power from the external apparatus. In this case, power supplied to the LAN chip circuit 21 is power from the PoE power supply circuit 30.

At that time, the power from the circuit 23 is not supplied to the LAN chip circuit 21 although supplied to devices other than the LAN chip circuit 21

According to another case, even when the control circuit 22 makes a connection with the PoE power supply circuit 30 via the power line 31, the circuit 30 does not obtain power from the external apparatus. In this case, no power is supplied to the LAN chip circuit 21.

The power control procedure of the notebook PC having the configuration shown in FIG. 1 will be explained below.

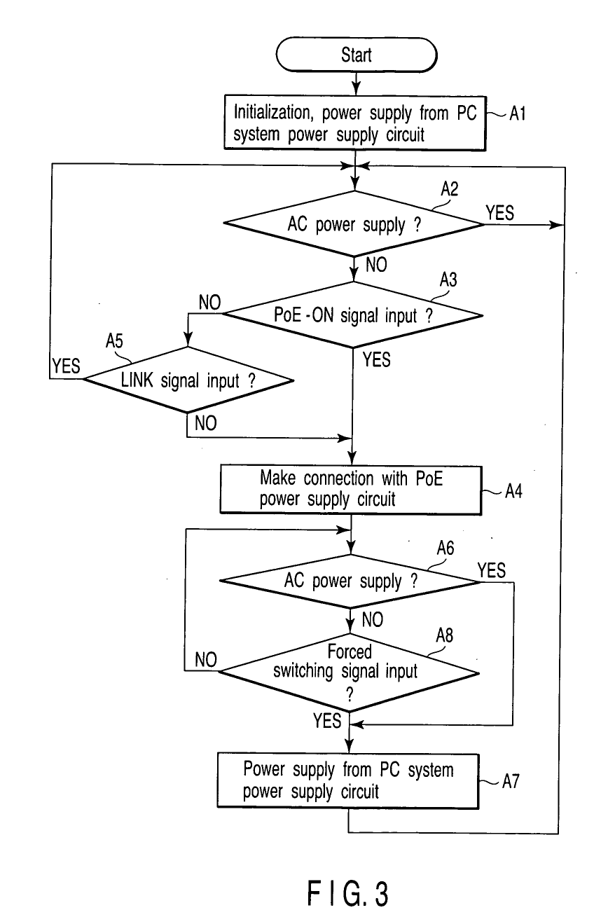

FIG. 3 is a flowchart to explain the power control procedure executed by the notebook PC according to the first embodiment of the present invention.

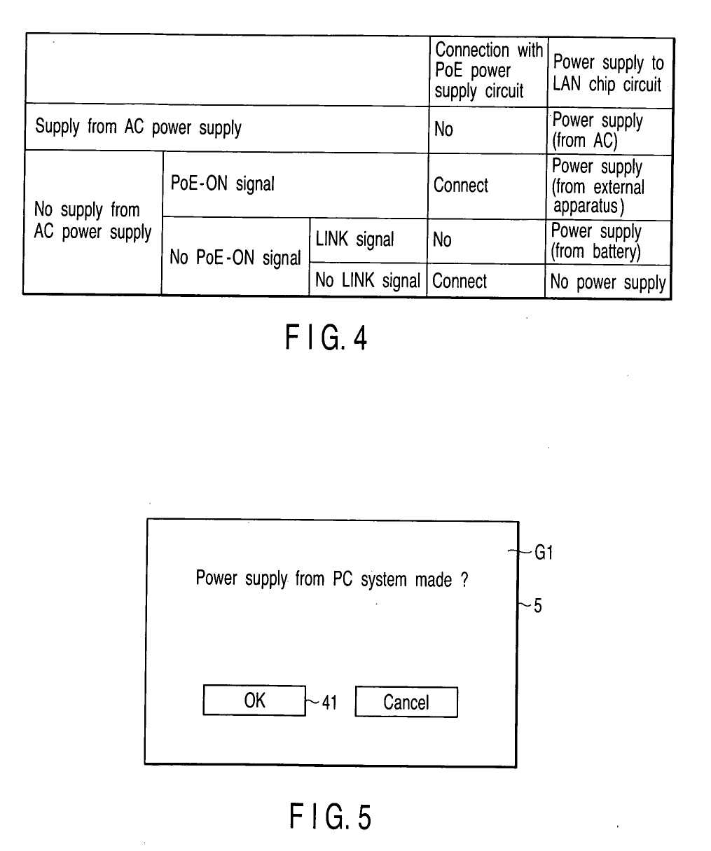

FIG. 4 is a table to explain connection and power supply when the notebook PC according to the first embodiment of the present invention executes the power control procedure.

Specifically, the table shows the connection of the control circuit 22 with the PoE power supply circuit 30 via the power line 31, and the power supply to the LAN chip circuit 21.

In the column item “Power supply to LAN chip circuit” shown in FIG. 4, “Power supply (from AC)” implies that power from an AC power supply is supplied to the LAN chip circuit 21.

In FIG. 4, “Power supply (from external apparatus)” implies that power from the external apparatus connected with the LAN connector 28 via the LAN cable 29 is supplied to the LAN chip circuit 21. In FIG. 4, “Power supply (from battery)” implies that power from the battery 26 is supplied to the LAN chip circuit 21.

The following matters are assumed when the notebook PC executes the power control procedure. Specifically, according to one assumption, the system state of the notebook PC is in the shutdown state. According to another assumption, the PC system power supply circuit 23 obtains power from the battery 26 if power from the AC power supply is not obtained.

The chip set 12 detects the press of the power switch 6 by user. Then, the chip set 12 instruct the PC system power supply circuit 23 to supply power to devices including the LAN chip circuit 21 via the control circuit 22 by the circuit 23. By doing so, OS and various application programs boot (step A1).

The PC system power supply circuit 23 outputs a switching signal showing whether or not power from the AC power supply is supplied, to the control circuit 22.

Specifically, the PC system power supply circuit 23 outputs a switching signal “AC” to the control circuit 22 if it obtains power from the AC power supply via power supply plug 25 and power cord 24. Moreover, the circuit 23 outputs a switching signal “BAT (battery)” to the control circuit 22 if it obtains power from the battery 26, and not power from the AC power supply.

If the PoE power supply circuit 30 obtains power from the external apparatus via LAN cable 29 and LAN connector 28, it outputs a signal showing the foregoing matter, that is, PoE-ON signal to the control circuit 22 via the control signal line 32. If the PoE power supply circuit 30 does not obtain power from the external apparatus, it does not output the PoE-ON signal.

The control circuit 22 determines whether or not the PC system power supply circuit 23 obtains power from the AC power supply, based on the kind of the switching signal from the circuit 23 (step A2).

If a switching signal input from the circuit 23 is the switching signal “BAT” (NO in step A2), the control circuit 22 determines whether or not the PoE-ON signal is input from the circuit 30 (step A3).

If the control circuit 22 determines that the PoE-ON signal is input from the PoE power supply circuit 30 (YES in step A3), it makes a connection with the circuit 30 via the PoE power supply power line 31. By doing so, the power supply to the LAN chip circuit 21 is switched from the PC system power supply circuit 23 to the PoE power supply circuit 30 (step A4).

The foregoing procedures are taken, and thereby, when the notebook PC is powered by battery, power is supplied to the LAN chip circuit 21 from the PoE power supply circuit 30. On the other hand, power of the control circuit 22 obtained from the battery 26 is not supplied to the LAN chip circuit 21.

Therefore, it is possible to extend the operable time when the notebook PC is powered by battery in a state that the operation of the notebook PC is held.

Here, the control circuit 22 once supplies power from the circuit 23 to the LAN chip circuit 21 when the power of the notebook PC is made. Then, the control circuit 22 is supplied with the switching signal “BAT” from the circuit 23, and the PoE-ON signal from the PoE power supply circuit 30.

In this case, the control circuit 22 switches the power supply to the LAN chip circuit 21 from the circuit 23 to the PoE power supply circuit 30.

On the other hand, in the first time when the power of the notebook PC is made, the control circuit 22 is supplied with the switching signal “BAT” from the circuit 23 and the PoE-ON signal from the PoE power supply circuit 30.

In this case, the power from the PoE power supply circuit 30 is supplied to the LAN chip circuit 21 without receiving the supply of power from the circuit 23.

The LAN chip circuit 21 determines whether or not data communication with the external apparatus connected to the LAN connector 28 via the LAN cable 29 is established. If the LAN chip circuit 21 determines that the data communication is established, it outputs a LINK signal showing that to the control circuit 22.

The external apparatus as a target of the foregoing data communication may have a function of supplying power to the notebook PC, or may be another apparatus.

Specifically, the control circuit 22 determines whether or not the LINK signal from the LAN chip circuit 21 is input (step A5) in the following case. According to the case, the control circuit 22 is supplied with the switching signal “BAT” from the PC system power supply circuit 23 (NO in step A2). On the other hand, the control circuit 22 is not supplied with the PoE-ON signal from the PoE power supply circuit 30 (NO in step A3).

If the control circuit 22 determines that the procedure result in step A5 is “YES”, this implies the following matter. Namely, the PoE power supply circuit 30 does not obtain power from the external apparatus while data communication between the LAN chip circuit 21 and the external apparatus is established.

In this case, the control circuit 22 does not make a connection with the PoE power supply circuit 30 via the power line 31. As a result, the LAN chip circuit 21 is continuously supplied with power from the PC system power supply circuit 23 (step A5→A2).

On the other hand, if the control circuit 22 determines that the procedure result in step A5 is “NO”, this implies the following matter. Namely, the PoE power supply circuit 30 does not obtain power from the external apparatus, and also, the foregoing data communication is not established.

In this case, the control circuit 22 makes a connection with the PoE power supply circuit 30 via the power line 31 (step A5→A4). As a result, the PoE power supply circuit 30 does not obtain power from the external apparatus, and also, the obtained power of the circuit 23 is not supplied to the LAN chip circuit 21. Consequently, the LAN chip circuit 21 is not supplied with power.

The control circuit 22 again determines the kind of the switching signal from the PC system power supply circuit 23 after the procedure of step A4 is taken (step A6). The procedure of step A6 is taken; as a result, the control circuit 22 determines in step A6 that the switching signal “AC” is input. That is, the PC system power supply circuit 23 obtains power from the AC power supply (YES in step A6).

In this case, the control circuit 22 stops making a connection with the PoE power supply circuit 30 via the power line 31 (step A6→A7). As a result, the LAN chip circuit 21 is again supplied with power of the PC system power supply circuit 23 obtained via the AC power supply.

The procedure of step A6 is taken; as a result, the control circuit 22 determines that the switching signal “BAT” is input from the PC system power supply circuit 23 (No in step A6). In this case, the control circuit 22 keeps the connection with the PoE power supply circuit 30 via the power line 31.

For example, the procedure of step A4 is taken without making the procedure of step A5. In other words, the external apparatus connected with the LAN cable 29 is a PoE-enabled apparatus.

In this case, user detaches the LAN cable 29 from the LAN connector 28 after the procedure of step A4 is taken, and thereby, the power supply to the PoE power supply circuit 30 is stopped. Therefore, the supply of power to the LAN chip circuit 21 from the control circuit 22 is also stopped.

If user again connects the detached LAN cable 29 to the LAN connector 28, power is again supplied to the PoE power supply circuit 30. In this state, the foregoing procedure of step A4 is taken, and thereby, a connection of the control circuit 22 with the PoE power supply circuit 30 via the power line 31 is made. Therefore, the power supply to the LAN chip circuit 21 via the PoE power supply circuit 30 is restarted.

However, if the external apparatus connected with the LAN cable 29 is a non-PoE-enabled apparatus. In this case, even if the LAN cable 29 is changed from a state of being not connected with the LAN connector 28 to a state of being connected with there after the procedure of step A4 is taken, no power is supplied to the PoE power supply circuit 30.

In other words, the procedure of step A4 is taken, and thereby, a connection of the control circuit 22 with the PoE power supply circuit 30 via the power line 31 is kept. As a result, the power supply to the LAN chip circuit 21 is required; nevertheless, the power is not supplied to the LAN chip circuit 21.

FIG. 5 is a view showing a setting screen when the notebook PC according to the first embodiment of the present invention executes the power control procedure.

As described above, it is evident that the external apparatus is a non-PoE-enabled apparatus. Thus, user connects the LAN cable 29 connected with the external apparatus to the LAN connector 28. In this case, user makes a predetermined operation using the keyboard 4 to display a setting screen G1 (see FIG. 5) on the LCD 5, and thereafter, selects an OK icon 41 on the screen G1. The chip set 12 outputs a forced switching signal to the control circuit 22.

If the control circuit 22 is supplied with the forced switching signal (YES in step A8), it stops a connection with the circuit 30 via the power line 31 (step A7). As a result, the LAN chip circuit 21 is supplied with power based on power of the PC system power supply circuit 23 obtained from the battery 26. The notebook PC executes the foregoing procedure, and thereby, the effect is obtained.

Specifically, the power supply to the LAN chip circuit 21 is kept even if the external apparatus is not a PoE-enabled apparatus, and user detaches and attaches the LAN cable 29 from and to the LAN connector 28.

The power supply to the LAN chip circuit 21 is stopped as described above. In this case, power is again supplied to the LAN chip circuit 21 to normally operating the LAN chip circuit 21 again, and further, the LAN chip circuit 21 must be reset (initialized).

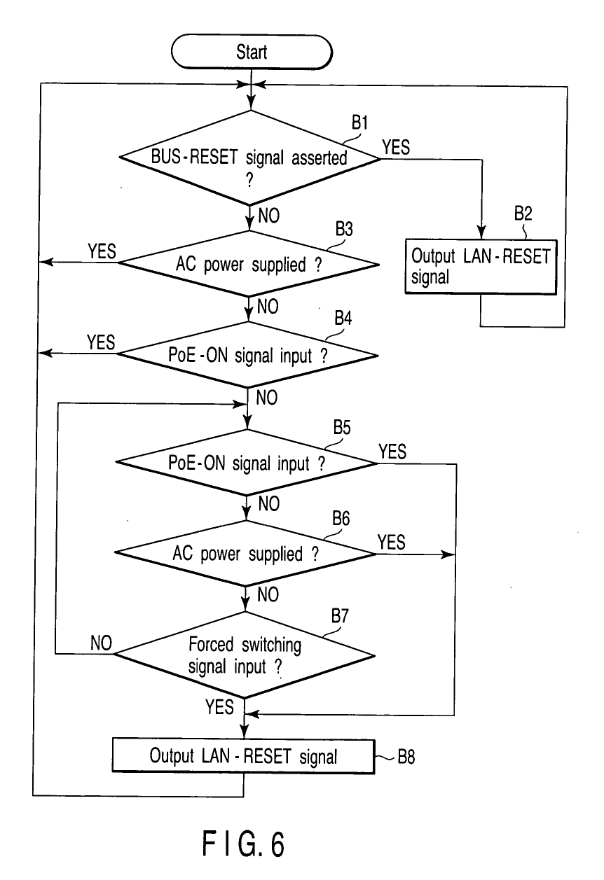

FIG. 6 is a flowchart to explain the reset procedure executed by the notebook PC according to the first embodiment of the present invention.

When user presses the power switch 6 so that the procedure of step A1 is taken, the PC system power supply circuit 23 outputs a BUS-RESET signal to the control circuit 22. When the control circuit 22 is supplied with the BUS-RESET signal, the BUS-RESET signal becomes an assert state (YES in step B1). Then, the control circuit 22 outputs a LAN-RESET signal to the LAN chip circuit 21 (step B2).

When receiving the LAN-RESET signal, the LAN chip circuit 21 is reset. By doing so, the LAN chip circuit 21 is operated.

If user removes the LAN cable 29 connected with the external apparatus from the LAN connector 28 to again make a connection, the LAN chip circuit 21 must be reset. In this case, however, the BUS-RESET signal from the PC system power supply circuit 23, that is, a trigger signal of the LAN-RESET signal is not input to the control circuit 22. Therefore the foregoing reset is not made.

Here, the following assumption is given. Specifically, the control circuit 22 is not supplied with the BUS-RESET signal. In other words, the BUS-RESET signal is in a deassert state (NO in step B1), and the control circuit 22 is supplied with the switching signal “BAT” from the PC system power supply circuit 23 (NO in step B3).

The control circuit 22 changes from a state of inputting no PoE-ON signal from the circuit 30 (NO in step B4) to a state of inputting the PoE-ON signal (YES in step B5).

In this case, the control circuit 22 determines that user connects the LAN cable 29 connected with the external apparatus to the LAN connector 28, that is, power is again supplied externally to the LAN chip circuit 21 to operate the circuit 21. Thus, the control circuit 22 outputs the LAN-RESET signal to the LAN chip circuit 21 (step B5→B8).

By doing so, even if user detaches and attaches the LAN cable 29 from and to the LAN connector 28 after power is made, the LAN chip circuit 21 is reset.

If the external apparatus connected with the LAN connector 28 via the LAN cable 29 is a PoE-enabled apparatus, the PoE-ON signal is input to the control circuit 22 when user connects the external apparatus with the LAN connector 28 via the LAN cable 29.

However, if the external apparatus is a non-PoE-enabled apparatus, no PoE-ON signal is input to control circuit 22 even if user detaches and attaches the LAN cable 29 from and to the LAN connector 28.

For this reason, the control circuit 22 determines as “NO” in step B4, and thereafter, supplied with the switching signal “AC” (YES in step B6) in a state that no PoE-ON signal is input (NO in step B5). In this case, the control circuit 22 takes the procedure of step B8.

In other words, the control circuit 22 sets a change of the kind of the switching signal as an output trigger of the LAN-RESET signal. By doing so, the LAN chip circuit 21 is reset even if user detaches and attaches the LAN cable 29 from and to the LAN connector 28 and the external apparatus is a non-PoE-enabled apparatus.

However, the change of the kind of the switching signal from the PC system power supply circuit 23 has no relation with the operation of detaching and attaching the LAN cable 29 from and to the LAN connector 28. Thus, even if the operation of detaching and attaching is made, the kind of the switching signal to the control circuit 22 is not necessarily changed.

For this reason, if the control circuit 22 determines as NO in step B5, it is supplied with the switching signal “BAT” (NO in step B6). In this case, the control circuit 22 is supplied with the foregoing forced switching signal (YES in step B7) to output the LAN-RESET signal to the LAN chip circuit 21 (step B7→B8).

By doing so, the LAN chip circuit 21 is reset even if the following case is given. Namely, the external apparatus connected with the LAN cable 29 is a non-PoE-enabled apparatus although user connects the LAN cable 29 to the LAN connector 28, and the kind of switching signal is unchanged from “BAT”.

As seen from the foregoing description, the notebook PC according to the first embodiment supplies power to the LAN chip circuit 21 based on power obtained by the PoE power supply circuit 30 even if the following case is given.

Namely, power from the battery 26 is supplied to the PC system power supply circuit 23 without being supplied to there from the AC power supply after power is made, and power is supplied to the PoE power supply circuit 30. Therefore, it is possible to extend the operable time when the notebook PC is powered using the battery in a state of keeping the communication function of the notebook PC.

### Second Embodiment

The second embodiment of the present invention will be described below. The notebook PC according to the second embodiment basically has the same appearance and internal circuit configuration as shown in FIG. 1 and FIG. 2. Therefore, the explanation of the same component is omitted.

The notebook PC of the first embodiment supplies power from the AC power supply to the PC system power supply circuit 23 or inputs the forced switching signal to the control circuit 22 to again operate the LAN chip circuit 21 if the following case is given. By doing so, the LAN-RESET signal is output to the LAN chip circuit 21.

According one case, a connection of the control circuit 22 with the PoE power supply circuit 30 via the power line 31 is made, and thereafter, the user again makes a connection after detaching the LAN cable 29 from the LAN connector 28.

According to another case, when a connection of the control circuit 22 with the PoE power supply circuit 30 via the power line 31 is made, the LAN cable 29 changes from a state of being removed from the LAN connector 28 to a state of being connected to there.

On the contrary, the notebook PC of the second embodiment has a function of switching the kind of power supplied to the LAN chip circuit 21 in accordance with the kind of power supplied to the PC system power supply circuit 23 if the following case is given.

According to the case, an external apparatus connected via the LAN cable 29 is a non-PoE-enabled apparatus, and user inserts the LAN cable 29 into the LAN connector 28.

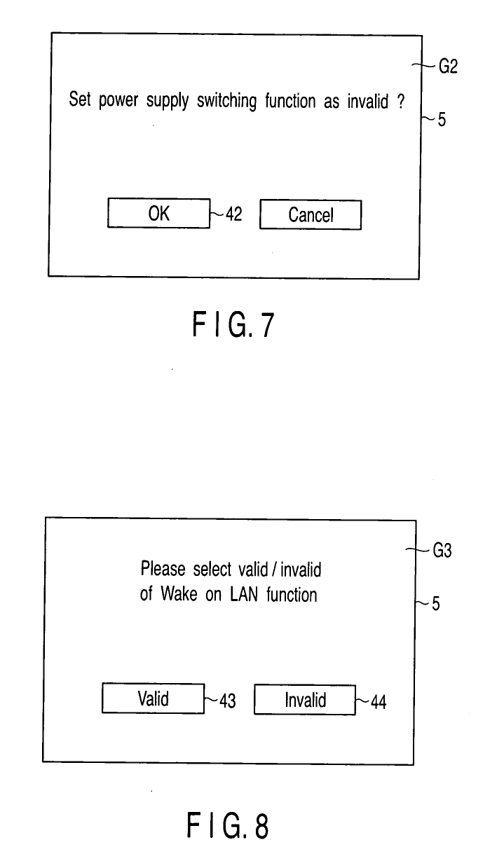

FIG. 7 is a view showing a setting screen when the notebook PC according to the second embodiment of the present invention executes the power control procedure.

Specifically, if it is evident that the external apparatus connected via the LAN cable 29 is a non-PoE-enabled apparatus, user makes a predetermined operation using the keyboard 4 to display a setting screen G2 (see FIG. 7) on the LCD 5. Then, user selects an OK icon 42 on the screen G2.

By doing so, it is set to invalidate the procedure of switching the kind of power supplied to the LAN chip circuit 21 in accordance with the kind of power supplied to the PC system power supply circuit 23.

If the foregoing setting is made, the chip set 12 outputs a control signal for instructing to invalidate the procedure of switching the power supply to the control circuit 22.

When receiving the control signal, the control circuit 22 sets power supplied to the LAN chip circuit 21 to power supplied to the PC system power supply circuit 23. In this case, the foregoing setting is made regardless of the condition that power supplied to the PC system power supply circuit 23 is supplied from which of the AC power supply or battery 26.

The procedure is taken, and thereby, power is normally supplied to the LAN chip circuit 21 without carrying out the operation for outputting the preceding forced switching signal even if the following case is give. According to the case, the external apparatus is a non-PoE-enabled apparatus, and user detaches and attaches the LAN cable 29, and further, power from the AC power supply is not supplied to the PC system power supply circuit 23.

### Third Embodiment

The third embodiment of the present invention will be described below. The notebook PC according to the third embodiment basically has the same appearance as shown in FIG. 1. Therefore, the explanation of the same component is omitted.

The notebook PC according to the third embodiment of the present invention has a “Wake on LAN” function. According to “Wake on LAN” function, the system state of the notebook PC is in a predetermined state other than the boot state, for example, suspend state.

In this case, the system state of the notebook PC is changed into the boot state in accordance with the control signal from the external apparatus connected with the LAN cable 29 inserted into the LAN connector 28. User makes a predetermined operation using the keyboard 4 to arbitrarily select whether or not he invalidates the “Wake on LAN” function.

FIG. 8 is a view showing a setting screen of the “Wake on LAN” function of the notebook PC according to the third embodiment of the present invention.

In order to validate the “Wake on LAN” function, user makes a predetermined operation using the keyboard 4 to display a setting screen G3 (see FIG. 8) on the LCD 5. Then, user selects a “valid” icon 43 on the screen G3. On the other hand, in order to invalidate the “Wake on LAN” function, user selects an “invalid” icon 44 on the screen G3.

The notebook PC according to the third embodiment can prevent a large reduction of the residual operable time when it is powered using battery and the operation of the “Wake on LAN” function is made.

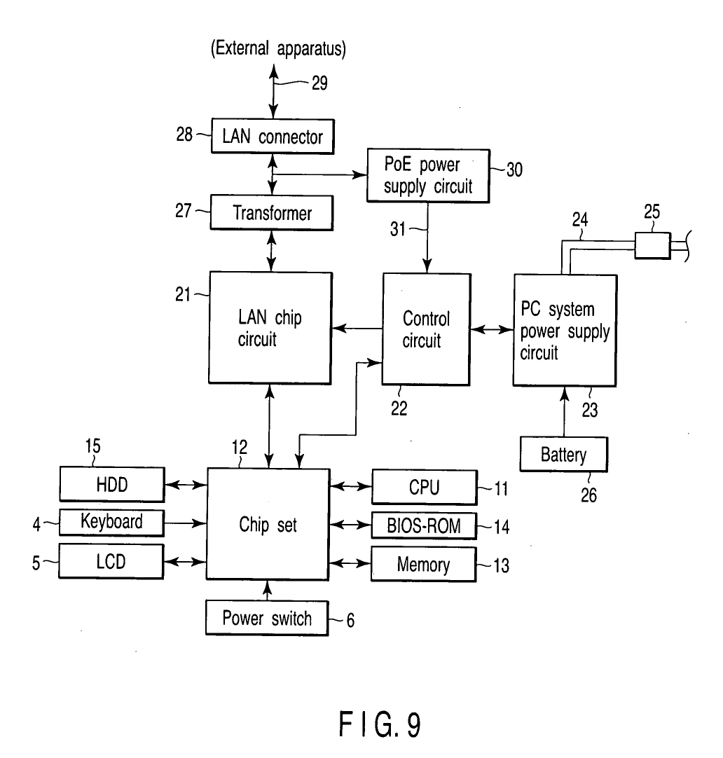

FIG. 9 is a block diagram showing the internal circuit configuration of the notebook PC according to the third embodiment. The internal circuit configuration of the notebook PC is basically the same as FIG. 2; therefore, the explanation about the identical component is omitted.

In the notebook PC according to the third embodiment, the PC system power supply circuit 23 outputs state signal, LAN power control signal and switching signal to the control circuit 22. Moreover, the notebook PC according to the third embodiment differs from that of the first embodiment in the following point. Specifically, no control signal line 32 for outputting the PoE-ON signal is interposed between the PoE power supply circuit 30 and the control circuit 22.

The LAN power control signal is a signal outputted to the control circuit 22 by the PC system power supply circuit 23 if the LAN function becomes valid. The state signal is a signal including information indicative of the system state of the notebook PC. A state signal “S0” is a signal indicative that the system state of the notebook PC is a boot state. A state signal “S3” is a signal indicative that the system state of the notebook PC is a suspend state. A state signal “S4” is a signal indicative that the system state of the notebook PC is a hibernation state. A state signal “S5” is a signal indicative that the system state of the notebook PC is a shutdown state.

In the suspend state, information relevant to the control during boot of the notebook PC is saved in the main memory 13, and then, devices including the HDD 15 become a stopped state. In the hibernation state, information relevant to the control during boot of the notebook PC is saved in the HDD 15, and then, devices including the HDD 15 become a stopped state.

When the “Wake on LAN” function becomes valid, even if the system state of the notebook PC is in any of the suspend, hibernation and shutdown states, power obtained from the circuit 23 or circuit 30 is supplied to the LAN chip circuit 21.

According to the “Wake on LAN” function of the third embodiment, the system state is changed into the boot state in accordance with the external instructions even if the system state of the notebook PC is in any of the suspend, hibernation and shutdown states.

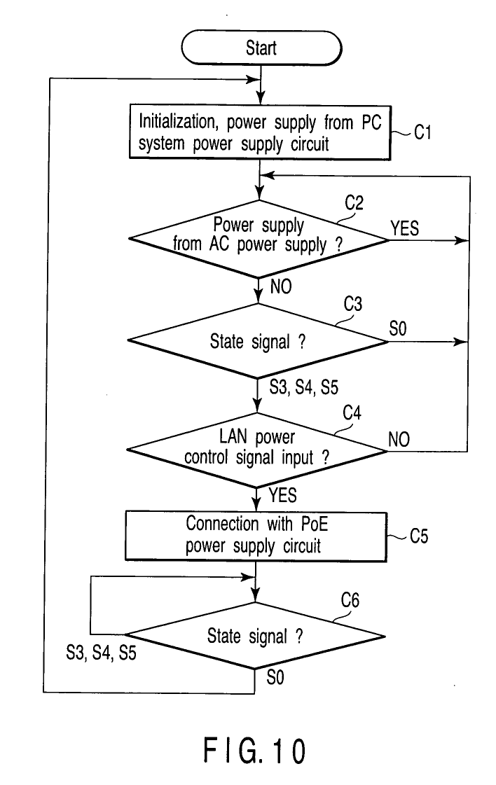

FIG. 10 is a flowchart to explain the power control procedure executed by the notebook PC according to the third embodiment of the present invention.

The following assumption is given when the notebook PC according to the third embodiment executes the power control procedure executed. Namely, the system state of the notebook PC is in a shutdown state, and the PC system power supply circuit 23 obtains power from the AC power supply or the battery 26.

When user presses the power switch 6, the chip set 12 detects it. The chip set 12 instructs the PC system power supply circuit 23 to supply power obtained by the circuit 23 to devices. By doing so, OS and various application programs boot (step C1).

The PC system power supply circuit 23 outputs a switching signal, which is indicative of the power supply from the AC power supply, to the control circuit 22. Specifically, the circuit 23 outputs the switching signal “AC” to the control circuit 22 if obtains power from the AC power supply via power supply plug 25 and power cord 24. Moreover, the circuit 23 outputs the switching signal “BAT” to the control circuit 22 if it obtains power from the battery 26, and not the AC power supply.

The control circuit 22 determines the kind of switching signal from the PC system power supply circuit 23 to determine whether or not the circuit 23 obtains from the AC power supply (step C2).

If the control circuit 22 obtains the switching signal “BAT” from the PC system power supply circuit 23 (NO in step C2), it determines the kind of state signal from the circuit 23 (step C3).

If the control circuit 22 determines in step C3 that the state signal input from the circuit 23 is “S3”, “S4” or “S5”, it determines that the system state is controllable using the “Wake on LAN” function. Then, the control circuit 22 determines whether or not the LAN power control signal is inputted from the PC system power supply circuit 23 (step C4).

If “YES” is given in step C4, the control circuit 22 determines that the “Wake on LAN” function is valid. Then, the control circuit 22 makes a connection with the PoE power supply circuit 30 via the power line 31 (step C5).

In this case, the circuit 30 is always supplied with power from the external apparatus connected via LAN connector 28 and LAN cable 29. As a result, the LAN chip circuit 21 is supplied with power based on the power obtained from the PoE power supply circuit 30.

After the procedure of step C5 is taken, the control circuit 22 again determines the kind of the state signal from the PC system power supply circuit 23 (step C6).

If the control circuit 22 determines in step C6 that the state signal input from the circuit 23 is “S0”, it determines that the system state is not controllable using the “Wake on LAN” function. Then, the control circuit 22 stops a connection with the PoE power supply circuit 30 via the power line 31 (step C6→C1).

As a result, the LAN chip circuit 21 is supplied with power based on power of the PC system power supply circuit 23 obtained from the battery 26.

The foregoing procedure is taken, and thereby, the LAN chip circuit 21 is supplied with power supplied from PC system power supply circuit 23 in the following condition.

According to the condition, the notebook PC is powered by battery, and the “Wake on LAN” function is valid, and further, the system state of the notebook PC is any of suspend, hibernation and shutdown states.

In this case, the power obtained from the battery 26 is not supplied to the LAN chip circuit 21. Therefore, the residual operable time is prevented from being largely reduced when the notebook PC is power by battery in a state that the “Wake on LAN” function is operating.

In this case, no special limitation is made so long as the following procedure sequence is given. Specifically, in the procedures from step C2 to C4, the notebook PC is powered by battery, and the state signal input to the control circuit 22 is any of “S3”, “S4” or “S5”.

If the LAN power control signal is input to the control circuit 22 from the PC system power supply circuit 23, the flow proceeds to the procedure of step C5.

According to the third embodiment of the present invention, the notebook PC switches power supplied to the LAN chip circuit 21 from power supplied from the circuit 23 to power supplied from the circuit 30 under the following condition.

According to the condition, the notebook PC is powered by battery, and the “Wake on LAN” function is valid. However, the present invention is not limited to above.

The power saving effect is obtained even if the following function is given so long as it operates the LAN chip circuit 21 by supplying power to the circuit 21 when the system state of the notebook PC is in states other than the boot state.

The function is a network management function. Specifically, the function of making communications between the LAN chip circuit 21 and the external apparatus is valid regardless of the system state of the notebook PC. In this case, power supplied to the LAN chip circuit 21 is switched from power supplied from the circuit 23 to power supplied from the circuit 30.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a connector which is connected with an external apparatus;
a communication control unit which performs communication with the external apparatus via the connector;
a first power supply circuit which supplies an electric power obtained from an external power supply to the communication control unit;
a second power supply circuit which supplies an electric power obtained from the external apparatus via the connector to the communication control unit; and
a control unit which supplies an electric power obtained from the first power supply circuit to the communication control unit when the first power supply circuit obtains an electric power from the external power supply, and which supplies an electric power obtained from the second power supply circuit to the communication control unit when the first power supply circuit does not obtain an electric power from the external power supply.

2. The apparatus according to claim 1, further comprising:
a setting unit which sets whether or not a function of stopping switching a source of power supply supplied to the communication control unit is valid,
wherein the control unit which switches a source of power supply to the communication control unit between the first and second power supply circuit so that the first power supply circuit supplies an electric power to the communication control unit regardless of whether or not the first power supply circuit obtains an electric power from the external power supply when the setting unit sets the function as being valid.

3. An electronic apparatus comprising:
a connector which is connected with an external apparatus;
a communication control unit which performs communication with the external apparatus via the connector;
a first power supply circuit which supplies an electric power obtained from an external power supply to the communication control unit;
a second power supply circuit which supplies an electric power obtained from the external apparatus via the connector to the communication control unit;
a setting unit which sets whether or not a function of operating the communication control unit is valid when an operating state of the electronic apparatus is in a predetermined state different from a boot state; and
a control unit which supplies an electric power obtained from the first power supply circuit to the communication control unit when the setting unit does not set the function as being valid or when the setting unit sets the function as being valid and the first power supply circuit obtains an electric power from the external power supply.

4. The apparatus according to claim 3, wherein the control unit supplies an electric power obtained from the second power supply circuit to the communication control unit when the setting unit sets the function as being valid and the first power supply circuit does not obtain an electric power from the external power supply.

5. The apparatus according to claim 3, wherein when the setting unit sets the function as being valid, the operating state of the electronic apparatus is changed into a boot state according to an instruction from an external apparatus via the connector when the operating state of the electronic apparatus is in a predetermined state different from the boot state.

6. The apparatus according to claim 3, further comprising:
a determination unit which determines the operating state of the electronic apparatus,
wherein the control unit which supplies an electric power obtained from the first power supply circuit to the communication control unit when the setting unit sets the function as being valid, and the first power supply circuit obtains an electric power from the external power supply, and further, the operating state determined by the determination unit is not in a predetermined state different from the boot state.

7. The electronic apparatus according to claim 4, further comprising:
a determination unit which determines the operating state of the electronic apparatus,
wherein the control unit which supplies an electric power obtained from the second power supply circuit to the communication control unit when the setting unit sets the function as being valid, and the first power supply circuit does not obtain a power from the external power supply, and further, the operating state determined by the determination unit is in the predetermined state.

8. A power control method of an electronic apparatus including: a connector which is connected with an external apparatus; a communication control unit which performs communication with the external apparatus via the connector; a first power supply circuit which supplies an electric power obtained from an external power supply to the communication control unit; a second power supply circuit which supplies an electric power obtained from the external apparatus via the connector to the communication control unit, the method comprising:
supplying an electric power obtained from the first power supply circuit to the communication control unit when the first power supply circuit obtains an electric power from the external power supply, and supplying an electric power obtained from the second power supply circuit to the communication control unit when the first power supply circuit does not obtain an electric power from the external power supply.

9. The method according to claim 8, further comprising:
setting whether or not a function of stopping switching a source of power supply supplied to the communication control unit is valid, and
switching a source of power supply to the communication control unit between the first and second power supply circuit so that the first power supply circuit supplies an electric power to the communication control unit regardless of whether or not the first power supply circuit obtains an electric power from the external power supply when the function is set as being valid.
